(19) United States
(12) Patent Application Publication
(10) Pub. No.: US 2010/0045020 A1
(43) Pub. Date: Feb. 25, 2010

(54) MURAL MOSAIC BOOK

(76) Inventors: Phil ALAIN, Edmonton (CA); Paul LAVOIE, St. Albert (CA); Lewis LAVOIE, St. Albert (CA)

Correspondence Address: SHERIDAN ROSS PC, 1560 BROADWAY, SUITE 1200, DENVER, CO, 80202, US

(21) Appl. No.: 12/194,253

(22) Filed: Aug. 19, 2008

(51) Int. Cl. B42D 1/00

(52) U.S. Cl. 281/38

(57) ABSTRACT

A book, for use in creating a mosaic, is provided. The book can comprise a plurality of pages depicting individual and distinct artistic images that, when arranged in abutting relationship, combine to form a large unitary mosaic image.

### TECHNICAL FIELD

The present disclosure relates to a book and a method of using the book for the creation of a mosaic image. More specifically, the present disclosure relates to a book and a method for using the pages of the book to create a mural mosaic.

### BACKGROUND

Artistic mosaics for the purpose of decorative art are well known. Commonly, the art of mosaics comprises the creation of a singular image by positioning small pieces of coloured glass, stone or other material in a predetermined pattern. Other techniques comprise combining small pieces of glass or tile that are shaped in a particular pattern such that the smaller pieces, when aligned in accordance with their shapes, create the shape of a larger, unitary pattern.

The creation of large and interesting pieces of art, such as a mosaic, can be difficult, particularly for young adults and children. A number of games and art design products, such as colour-by-numbers or stencil art, provide quick and easy means for creating works of art without the need for advanced artistic skills. These products, however, commonly utilize smaller elements, such as pieces of coloured glass, that do not, themselves create individual works of art.

There is a desire, therefore, to create a book and a method for using the book, for creating a mosaic utilizing unitary, from individual pieces of art.

### SUMMARY

A book, for use in creating a mosaic image, is described herein, wherein the book comprises a plurality of individual pages depicting a separate and distinct artistic image. The pages of the book may be removed from the book and positioned in abutting relationship according to a pre-determined pattern or grid to form a larger, unitary, mosaic image.

The predetermined pattern or grid can be created upon a smooth planar surface, such as a wall.

The book, as defined herein, can further comprise a step-by-step set of instructions for creating a mosaic image, said instructions comprising the steps of:
removing the individual pages from the book, wherein each page depicts a distinct artistic image;
positioning the individual pages in an abutting relationship according to a predetermined grid; and
appending the pages to form a larger unitary image.

### DESCRIPTION OF THE DRAWINGS

FIG. 1 is a perspective view of the book, in an open position, showing the reference numbers on the back surface of one page and an artistic image on the front of the adjacent page.

FIG. 2 is a plan view of the grid.

FIG. 3 is a perspective view of a small image being applied.

FIG. 4 is a plan view of an example of a large image made up of independent, small artistic images.

### DESCRIPTION OF THE EMBODIMENTS

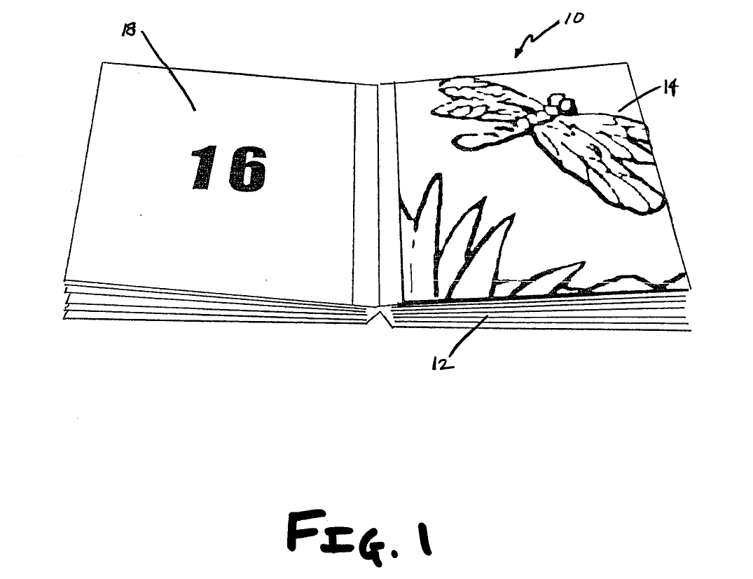

A book, for creating a mosaic image, generally identified by reference numeral 10, will now be described with reference to FIGS. 1-3.

Having regard to FIG. 1, book 10 comprises a plurality of individual pages 12. Each page 12 of book 10 can depict a separate, artistic design or small image 14, such that book 10 can form a common picture book in its original form. In one embodiment, each small image 14 on pages 12 of book 10 can be a reproduction of an original piece of art created by any number of artists. In another embodiment, smaller images 14 can be related to a common theme, such as, for example, the depiction of animals.

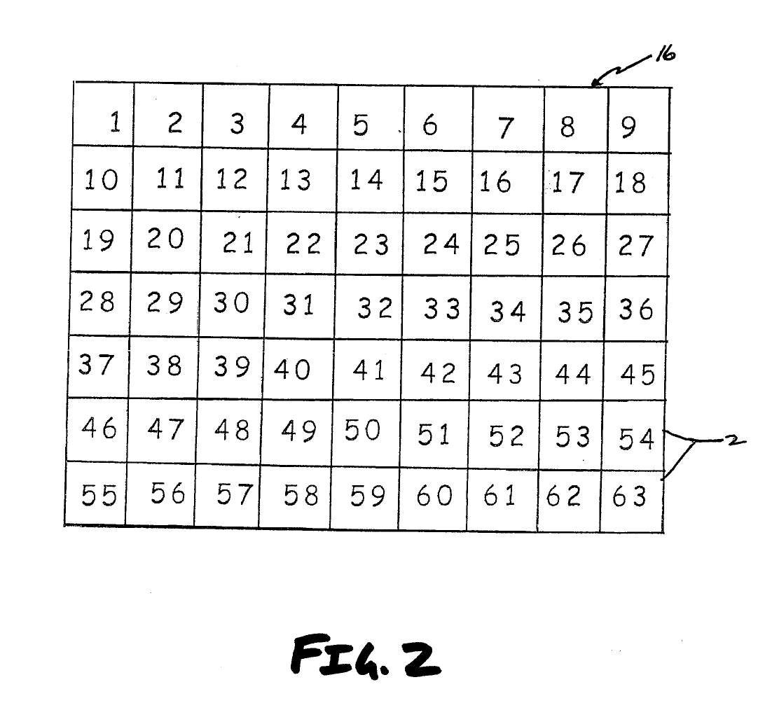

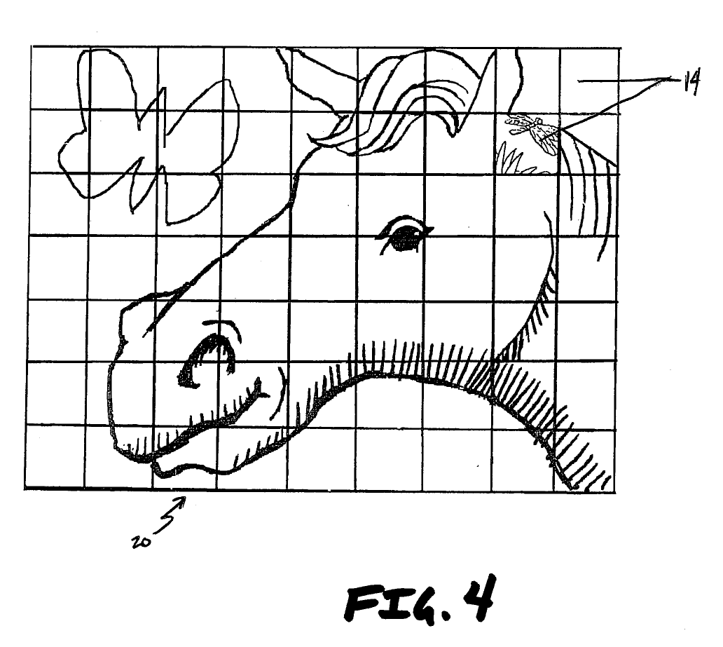

The small images 14 can be specifically designed according to a predetermined, original, concept or large image 20 (see FIG. 4), such that, when aligned in an abutting relationship upon a common plane, the small images 14 combine to form large image 20. By way of example, large image 20, which can be as large as 48″ high by 72″ long, can comprise an original depiction of a horse. The large image 20 of the horse can then be divided according to a predetermined grid 16 into smaller panels 22 (see FIG. 2). Each panel 22, which can be a 4″×4″ square, can provide a template from which small image 14 can be created.

Once created, each panel 22 can comprise:
a) a particular colour scheme, such that the spectrum of colours used in small image 14 complies with the overall design of large image 20; and
b) a particular colour template, such that the pattern of colours complies with the overall design of large image 20. Accordingly, each small image 14 can comprise an original work of art created within the boundaries of the panel 22 template. Continuing with the example of large image 20 comprising a horse, a total of 216 small images 14, each comprising a distinct picture of an animal or nature setting, can be created to form large image 20 or mosaic.

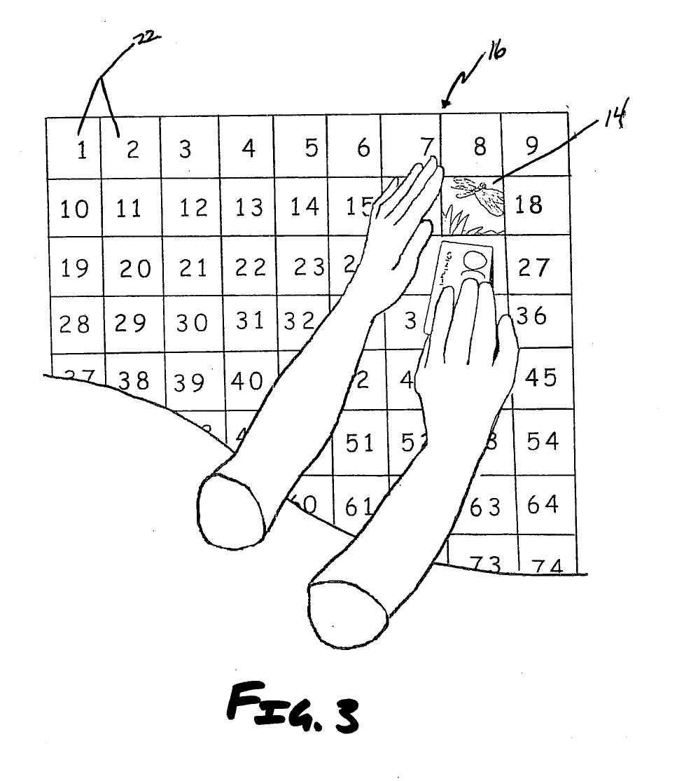

Book 10 can further comprise a method for creating large image 20 using individual small images 14. In one embodiment, the method for creating the large image 20 can comprise a step-by-step set of instructions 24, comprising:
1. creating a grid 16 having a predetermined size and shape. In one embodiment, grid 16 can be formed on a planar surface, such as a wall or a smooth board (see FIG. 2);
2. removing each individual page 12 having a small image 14 from book 10;
3. affixing each individual page 12 according to a predetermined mosaic arrangement upon grid 16 (see FIG. 3). The predetermined grid arrangement can comprise placing reference number 18 on the reverse or back side of page 12, wherein said reference number 18 can correspond to the appropriate panel 14 on grid 16; and
4. repeating step 3 until the entire mosaic image, such as the horse, is created.

Although a few embodiments have been shown and described, it will be appreciated by those skilled in the art that various changes and modifications might be made without departing from the scope of the invention. The terms and expressions used in the preceding specification have been used herein as terms of description and not of limitation, and there is no intention in the use of such terms and expressions of excluding equivalents of the features shown and described or portions thereof, it being recognized that the scope of the invention is defined and limited only by the claims that follow.

The embodiments of the invention in which an exclusive property or privilege is claimed are defined as follows:

1. A book, for use in creating a mosaic, said book comprising:
a plurality of pages, each page depicting a small artistic image; and
means for creating a mosaic using the pages,
wherein, when positioned in abutting relationship, the small images combine to form a large, unitary mosaic image.

2. The book as defined in claim 1 wherein the means for creating the mosaic image comprises a set of step-by-step instructions comprising:
a) removing the pages from the book; and
b) positioning the pages in an abutting relationship according to a predetermined grid.

3. The book as defined in claim 2 wherein the predetermined grid is formed on a planar surface.

4. The use of a book for creating a mosaic, said use comprising:
a) removing the pages from the book, each page comprising a small artistic image;
b) positioning the pages in an abutting relationship according to a predetermined grid; and
c) appending the pages to form a large, unitary mosaic image.

5. The use as defined in claim 4 wherein the predetermined grid is created on a planar surface.

6. A method for creating a mosaic, said method comprising the following steps:
a) providing a book comprising a plurality of pages, each page depicting a small artistic image;
b) removing the pages from the book; and
c) positioning the pages in abutting relationship according to a predetermined pattern or grid, wherein the small images combine to form a large, unitary mosaic image.

7. The method as defined in claim 6 wherein the predetermined grid is created on a planar surface.
